(19) United States
(12) Patent Application Publication
(10) Pub. No.: US 2011/0294365 A1
(43) Pub. Date: Dec. 1, 2011

(54) ELASTIC ELECTRICAL CONTACT

(75) Inventors: FENG-JUN WANG, Shenzhen City (CN); WEN-BING ZHOU, Shenzhen City (CN); TAO FU, Shenzhen City (CN); LI-SHA ZHU, Shenzhen City (CN)

(73) Assignees: HON HAI PRECISION INDUSTRY CO., LTD., Taipei Hsien (TW); HONG FU JIN PRECISION INDUSTRY (ShenZhen) CO., LTD., Shenzhen City (CN)

(21) Appl. No.: 12/962,603

(22) Filed: Dec. 7, 2010

(30) Foreign Application Priority Data
May 25, 2010 (CN) 201010182373.7

(51) Int. Cl. H01R 4/48

(52) U.S. Cl. 439/816

(57) ABSTRACT

An elastic electrical contact includes a base, a connecting member extending from an end of the base, and a resisting member extending from an end of the connecting member configured for resisting against an electronic element. The base includes a bottom surface being soldered to a circuit board and a top surface, and defines a through hole and a portion of tin between the bottom surface and the circuit board. When soldering to the circuit board, tin can extend through the through hole.

### BACKGROUND

1. Technical Field

The present disclosure relates to an elastic electrical contact.

2. Description of the Related Art

Elastic electrical contacts are widely used in electronic devices. One end of the elastic electrical contact is soldered to a circuit board of the electronic device, and the other opposite end of the elastic electrical contact resiliently presses against an electronic element of the electronic device, thus electrically connecting the electronic element to the circuit board. In certain instances, for example, when the circuit board is small but includes a large quantity of electrical components, only a small area is left for mounting the elastic electrical contact. The limited space can result in poor mounting of the elastic electrical contact, resulting in a weak connection and tendency for the contact to become disengaged from the circuit board.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, isometric view of an elastic electrical contact according to an exemplary embodiment.

FIG. 2 is a schematic, isometric view of the elastic electrical contact of FIG. 1, mounted on a circuit board.

### DETAILED DESCRIPTION

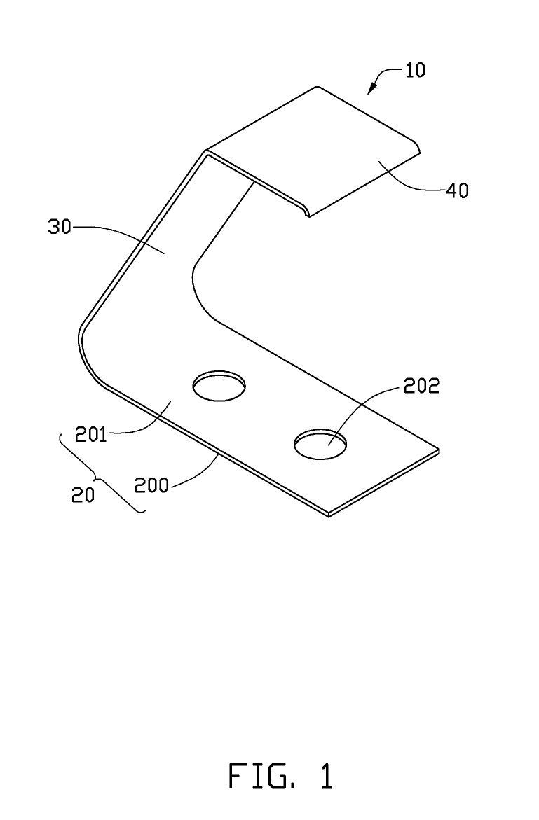

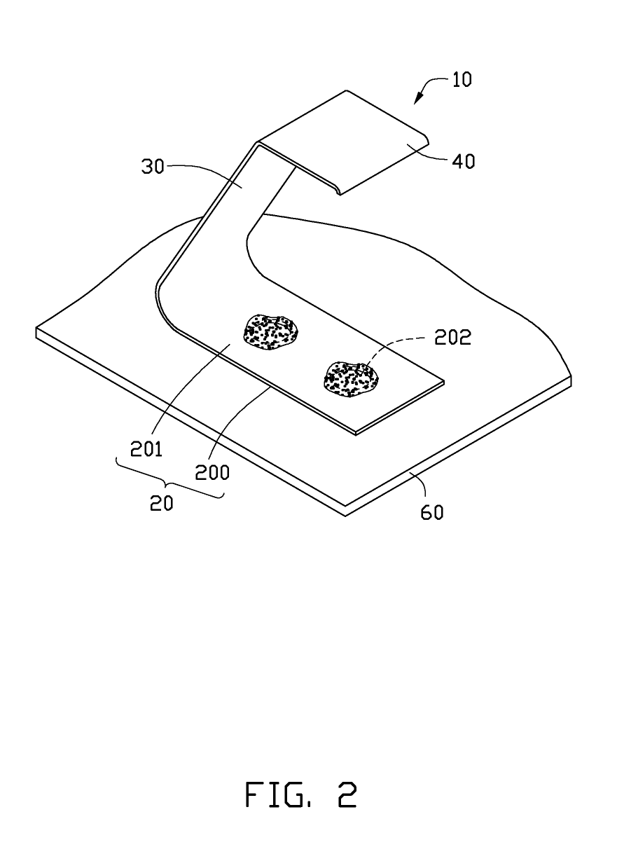

Referring to FIGS. 1, 2, an elastic electrical contact 10 according to an exemplary embodiment is disclosed. The contact 10 is substantially C-shaped, and includes a base 20, a connecting member 30 and a resisting member 40. The base 20 includes a bottom surface 200, and a top surface 201. The bottom surface 200 is configured for being soldered to a circuit board 60. In this embodiment, the base 20 is bar-shaped. The connecting member 30 extends upwardly from an end of the base 20. In this embodiment, the connecting member 30 is at an angle smaller than 90 degrees relative to the base 20. The resisting member 40 extends from an end of the connecting member 30 which is away from the base 20, and is configured for resiliently resisting against an electronic element (not shown). In this embodiment, the resisting member 40 is approximately parallel to the base 20. The length of the resisting member 40 is about one third of that of the base 20. In this case, the coefficient of elasticity of the resisting member 40 can be reduced. The free end of the resisting member 40 is bent toward the base 20 to prevent the free end scratching the electronic elements.

A pair of through hole 202 are defined in the base 20, near opposite ends of the base respectively. The through holes 202 are circular. In an alternative embodiment, the number of the through holes 202 may be varied according to need.

When assembling, soldering tins 70 are placed on the circuit board 60, and the contact 10 is mounted on the soldering tin 70 using surface mounting technology. A portion of the soldering tin 70 extends through the through hole 202 to the top surface 201, and the remainder of the soldering tin 70 remains between the bottom surface 200 and the circuit board 60. With the top surface 201 and the bottom surface 200 both being soldered, a strong connection is created between the contact 10 and the circuit board 60.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An elastic electrical contact comprising:
a base comprising:
a bottom surface configured for being soldered to a circuit board;
a top surface opposite to the bottom surface; and
a through hole defined in the base at an end of the bottom surface wherein when soldering, a portion of tin between the bottom surface and the circuit board passes through the through hole to the top surface;
a connecting member extending upwardly from an end of the base; and
a resisting member extending from an end of the connecting member away from the base, configured for resisting against an electronic element.

2. The elastic electrical contact as recited in claim 1, wherein a free end of the resisting member is bent toward the base.

3. The elastic electrical contact as recited in claim 1, wherein the connecting member is at an angle smaller than 90 degrees relative to the base.

4. The elastic electrical contact as recited in claim 1, wherein the resisting portion is approximately parallel to the base.

5. The elastic electrical contact as recited in claim 1, wherein the resisting member extends toward the free end of the base.

6. The elastic electrical contact as recited in claim 1, wherein the length of the resisting member is approximately one third of the length of the base.

7. The elastic electrical contact as recited in claim 1, wherein another through holes is defined in the base at an opposite end.

8. The elastic electrical contact as recited in claim 7, wherein the through holes are circular.
